(19) United States
(12) Patent Application Publication
(10) Pub. No.: US 2014/0249977 A1
(43) Pub. Date: Sep. 4, 2014

(54) INTERACTIVE FINANCIAL INSTITUTION INTERFACE

(71) Applicant: RAWLLIN INTERNATIONAL INC., Tortola (VG)

(72) Inventors: Vsevolod Kuznetsov, Sankt-Petersburg (RU); Nicholas Pushkin, Sankt-Petersburg (RU)

(73) Assignee: RAWLLIN INTERNATIONAL INC., Tortola (VG)

(21) Appl. No.: 13/783,579

(22) Filed: Mar. 4, 2013

(51) Int. Cl. G06Q 40/02

(52) U.S. Cl. CPC G06Q 40/02
USPC 705/35

(57) ABSTRACT

Disclosed are electronic systems and techniques for implementing an interactive financial interface that uses messages sent to and from financial institutions to view account information and interact with accounts at disparate financial institutions. The interactive financial interface can display balances of the accounts at the financial institutions, combined or individually, the interface can also show spending history, income history, and trend information which can be used to facilitate making financial decisions. Charts and graphs showing spending history and trends can also be sorted and filtered based on a number of criteria to better show relationships and patterns in the transaction history. Based on the trends and patterns, the interface can also provide recommendations to accomplish financial goals. The interface can also facilitate two-way communications with the financial institutions and instructions and commands can be sent to the financial institutions via the interface.

### TECHNICAL FIELD

The subject disclosure relates generally to electronic commerce, e.g., to an interactive interface that facilitates communications with financial institutions.

### BACKGROUND

Financial institutions (banks, credit unions, brokerage firms, investment banks, and etc.) will often provide interfaces that allow customers to view their account information, view their balance, transfer funds, make payments and other similar tasks. Due to security constraints, however, these interfaces are often designed so that the interface works with one financial institution exclusively. If a customer views an account via an interface with one financial institution, to view another account at another financial institution, the customer logs out and then navigates to the other financial institution's website to login and access the other financial institution's interface. In some cases, it may be possible to have both interfaces open at the same time, but each interface interacts with each financial institution separately.

Some of these financial institution interfaces have the option to enable notifications when changes are made to their accounts. Notifications can include information about account balances, payments, and withdrawals. These notifications can be sent by Short Message Service (“SMS”) message to a phone number that is associated with the accounts. These text messages can be useful to keep track of transactions, but do not provide a consolidated interface for interacting with the financial institutions.

The above-described description is merely intended to provide a contextual overview of common financial interfaces, and is not intended to be exhaustive.

### SUMMARY

Various non-limiting embodiments provide for an interactive interface for one or more financial institutions. In an example embodiment, a system comprises a memory to store computer-executable instructions and a processor communicatively coupled to the memory which facilitates execution of the computer-executable instructions. The computer-executable instructions can include instructions to receive a text message from a financial institution, wherein the text message comprises transaction information about a transaction that is associated with the financial institution. The instructions can also generate summary data based on an analysis of the transaction information and financial information that is determined prior to receiving the text message, wherein a type of summary data is generated based on a defined criterion. The instructions can also facilitate display of the transaction information, the financial information, and the summary on a mobile device.

In another example embodiment, a method comprises receiving, by a system comprising at least one processor, an text message that comprises information about one or more transactions that are associated with an account at a first financial institution. The method can also include analyzing the information about the one or more transactions and generating a financial summary based on the information about the one or more transactions. The method can also include facilitating displaying an interactive presentation showing the financial summary and financial information associated with the account at the first financial institution.

In another example embodiment, a tangible computer readable storage device has computer-executable instructions that, in response to execution, cause a system including a processor to perform operations comprising gathering data from a text message that was sent to a mobile device from a financial institution, wherein the data relates to transactions associated with a financial institution account. The operations can also include determining a financial trend based on an analysis of the data and generating an interactive presentation summarizing the financial trend wherein the interactive presentation is organized based on a defined criterion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of an interactive financial interface in accordance with various aspects described herein;

FIG. 2 is a block diagram illustrating an example, non-limiting embodiment of an interactive financial interface in accordance with various aspects described herein;

FIG. 3 is a block diagram illustrating an example, non-limiting embodiment of an interactive financial interface in accordance with various aspects described herein;

FIG. 4 is a block diagram illustrating an example, non-limiting embodiment of an interactive financial interface that makes financial recommendations in accordance with various aspects described herein;

FIG. 5 is a block diagram illustrating an example, non-limiting embodiment of an interactive financial interface that sends instructions to the financial institutions in accordance with various aspects described herein;

FIG. 6 is a block diagram illustrating an example, non-limiting embodiment of an interactive financial interface that can be organized and rearranged in accordance with various aspects described herein;

FIG. 7 illustrates a flow diagram of an example, non-limiting embodiment of a method for employing an interactive financial interface as described herein;

FIG. 8 illustrates a flow diagram of an example, non-limiting embodiment of a method for employing an interactive financial interface as described herein;

FIG. 9 illustrates a block diagram of an example electronic computing environment that can be implemented in conjunction with one or more aspects described herein;

FIG. 10 illustrates a block diagram of an example data communication network that can be operable in conjunction with various aspects described herein; and

FIG. 11 illustrates a block diagram of an example mobile network platform that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, an interactive financial interface system is provided that facilitates a single interface for viewing account information and interacting with accounts at disparate financial institutions. The interactive financial interface can display balances of the accounts at the financial institutions, combined or individually, the interface can also show spending history, income history, and trend information which can be used to facilitate making financial decisions. Charts and graphs showing spending history and trends can also be sorted and filtered based on a number of criteria to better show relationships and patterns in the transaction history. Based on the trends and patterns, the interface can also provide recommendations to accomplish financial goals. The interface can also facilitate two-way communications with the financial institutions and instructions and commands can be sent to the financial institutions via the interface.

In various non-limiting embodiments, the interactive financial interface can transmit and receive communications from the financial institutions via text messages. The text messages can be sent from the financial institutions to a mobile device with a phone number that has been selected for receiving notifications. The notifications can include header information identifying the account and/or financial institution, and can include information about account information or transaction information.

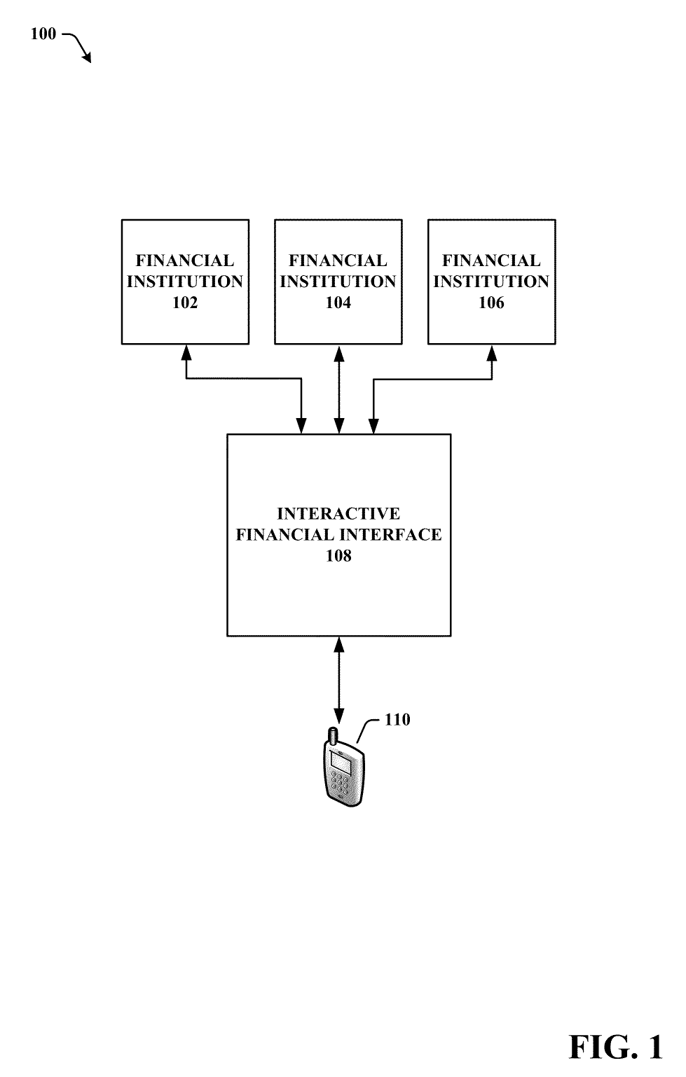

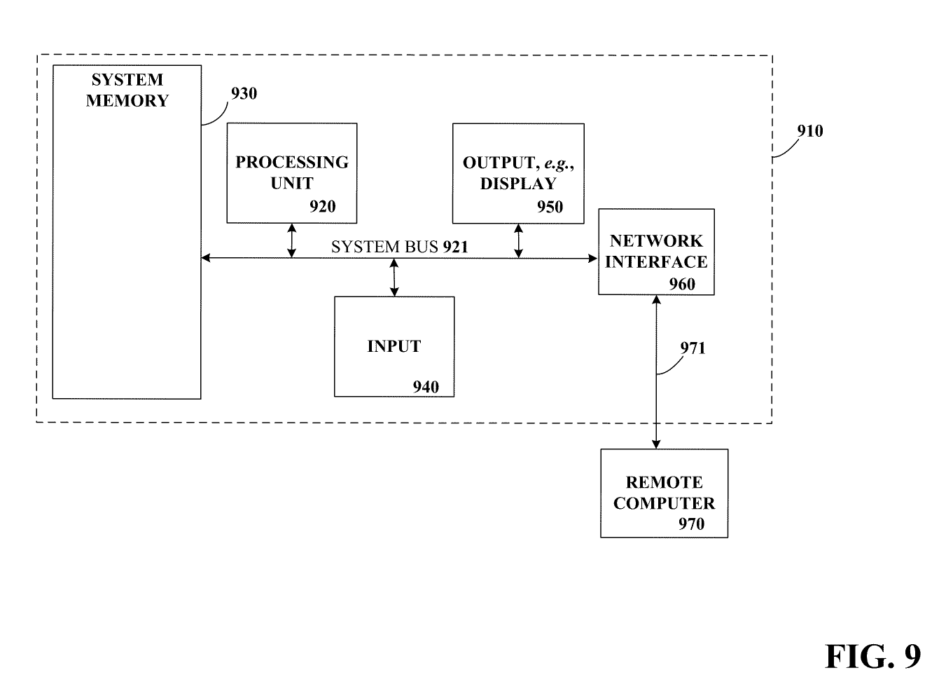

Referring now to FIG. 1, a block diagram illustrating an example, non-limiting embodiment of an interactive financial interface system 100 is shown. Generally, system 100 can include a memory that stores computer-executable instructions and a processor that executes the computer-executable instructions stored in memory, examples of which can be found with reference to FIG. 9. System 100 includes an interactive financial interface 108 that facilitates communications between financial institutions 102, 104, and 106 and mobile device 110.

The interactive financial interface 108 can receive messages and/or notifications from any of financial institutions 102, 104, and/or 106. The messages and/or notifications can be text messages in some embodiments, and emails or other electronic communications in other embodiments. The messages can contain information about accounts held at the financial institutions 102, 104, and 106 such as balances, transaction records and other types of information. The messages can also contain identifying information in the header (i.e., metadata) of the message that identifies which financial institution sent the message and the identity of the target recipient.

In some embodiments, financial institutions 102, 104, and 106 can send message updates at intervals, such as once per day, week, month, or other regularly defined period. In other embodiments, financial institutions 102, 104, and 106 can send message updates in response to certain triggers. For instance, messages can be sent in response to a transaction being made, or when the balance at the financial institution falls below a certain level.

In some embodiments, the messages can be sent to an email account specified by the customer at the financial institution. In other embodiments, text messages can be sent to a mobile number on record with the financial institution. The financial institution can determine whether to send an email or a text message based on preferences indicated in the customer's account at the financial institution.

Interactive financial interface 108 can extract data from the messages to provide contextual information about balances at financial institutions 102, 104, and 106. The contextual information can include balance information for each of the financial institutions 102, 104, and 106, as well as combined balance information, income, payments, transactions, and other relevant information that can be used to facilitate financial planning. The interactive financial interface 108 can compile the information and present the information in the form of graphs and charts on mobile device 110. The graphs and charts can show balance over time, transactions, rates of funds being transferred in and out and other relationships, patterns, and diagrams that can be utilized for financial planning.

The charts and graphs displayed on mobile device 110 can be sorted and filtered and otherwise manipulated for different views, perspectives, and analysis. For instance, the graphs can be filtered or sorted by time and/or date, transaction type, amount, and etc. Selections to change the presentation of the charts and graphs can be received via the mobile device 110.

In some embodiments, interactive financial interface 108 can also process and transmit requests, instructions, and/or commands from the mobile device 110 to one or more of financial institutions 102, 104, and 106. These instructions can indicate whether the financial institution should initiate a transaction, transfer funds, change account settings, and/or undertake other actions. The instructions can be sent in a similar manner as the message are received from the financial institution. For example, if messages are sent from financial institutions 102 and 106 as emails, and from financial institution 104 as a text message, interactive financial interface 108 can send instructions to financial institutions 102 and 106 as emails and to financial institution 104 as a text message.

In some embodiments, when sending messages as text messages, interactive financial interface 108 can spoof the messages such that it appears they are being sent by mobile device 110. Interactive financial interface 108 can include metadata in the text messages such that it appears they have been sent from a phone number or Mobile Subscriber Integrated Services Digital Network-Number (“MSISDN”) associated with mobile device 110. In other embodiments, when the messages are sent as emails, the messages can appear to be sent from an email address that is associated with an account at the financial institution. The effect of this is that financial institutions 102, 104, and 106 can send and receive communications to and from interactive financial interface 108, but to financial institutions 102, 104, and 106, it appears as if the messages are being sent to and from mobile device 110, with no interactive financial interface 108 in the middle intercepting and sending the messages.

It should be appreciated that the interactive financial interface 108 can display the information collected from financial institutions 102, 104, and 106 on electronic devices other than mobile device 110 in other embodiments. For instance, interactive financial interface 108 can display the information on any device which can access the internet. It should also be appreciated that in other embodiments, interactive financial interface 108 can receive messages from any number of financial institutions. The interactive financial interface 108 can receive messages from any accounts at financial institutions that are configured to send messages regarding account information to target recipients specified in the account settings.

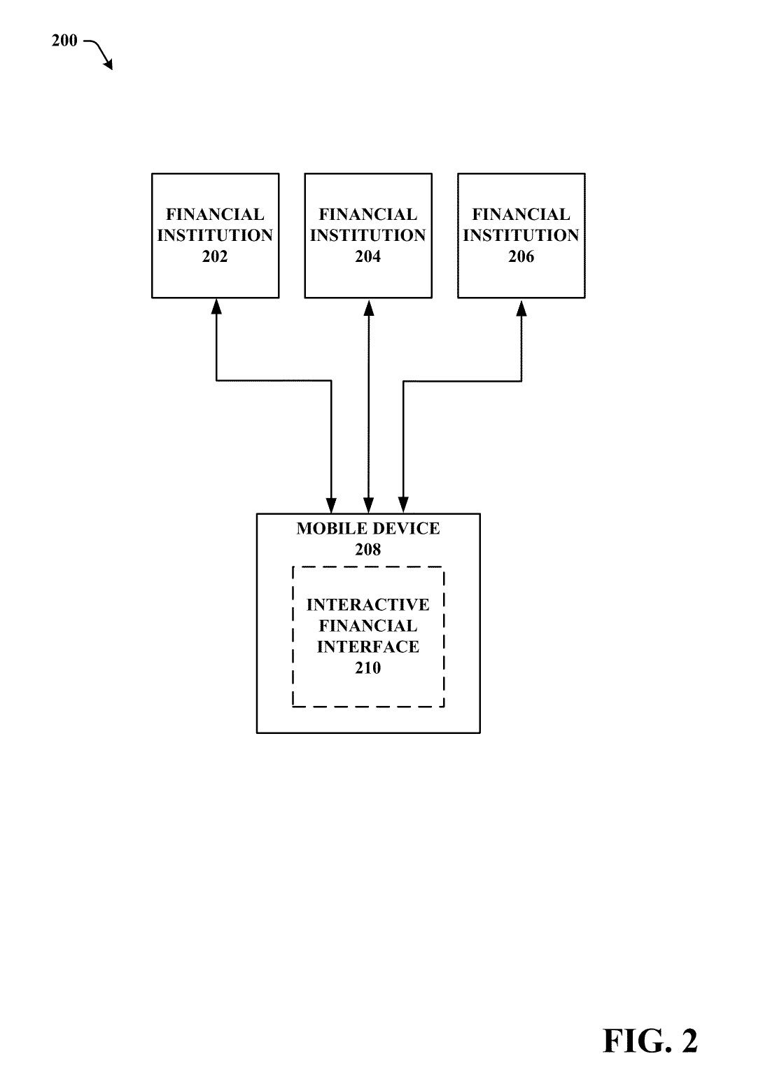

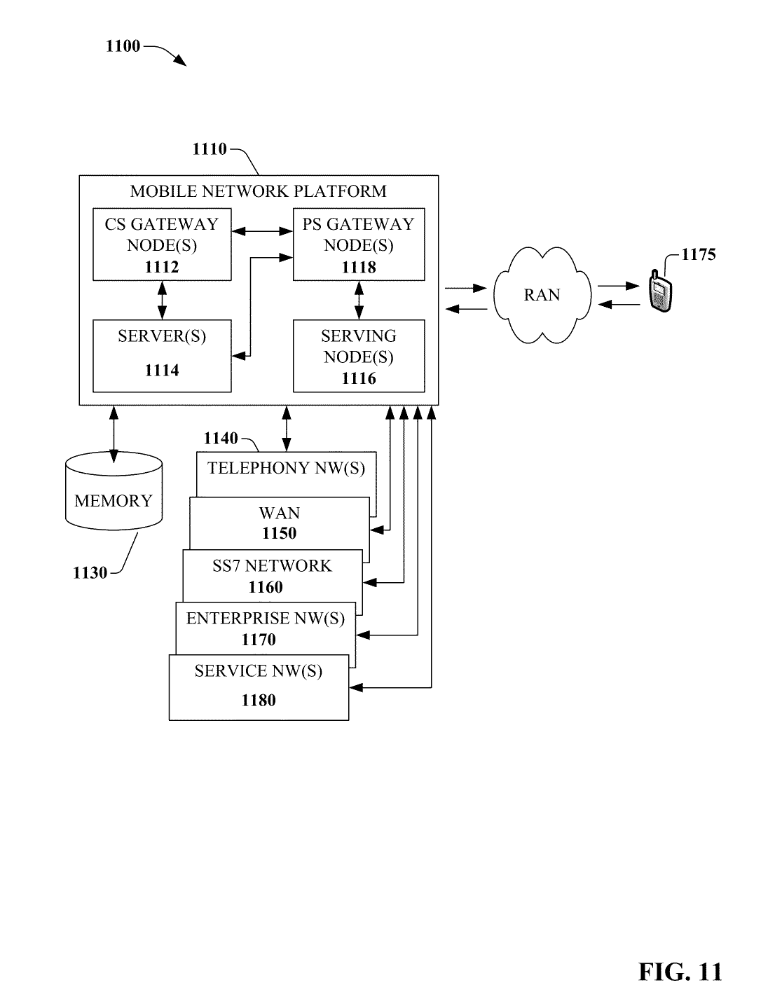

In FIG. 1 the interactive financial interface 108 is not part of, or an application running on mobile device 110 (or any other electronic device belonging to the customer). In other embodiments, the interactive financial interface 108 can run from a mobile device or other electronic device (see e.g., FIG. 2). The interactive financial interface 108 can be a Software as a Service (“SaaS”) that operates in the cloud. In other embodiments, interactive financial interface 108 can be an application, process, and/or service running on a mobile network (see e.g., FIG. 11).

Turning now to FIG. 2, a block diagram illustrating an example, non-limiting embodiment of an interactive financial interface system 200 in accordance with various aspects described herein is shown. Generally, system 200 can include a memory that stores computer-executable instructions and a processor that executes the computer-executable instructions stored in memory, examples of which can be found with reference to FIG. 9. System 200 includes an interactive financial interface 210 that operates on mobile device 208 to facilitates communications between financial institutions 202, 204, and 206 and mobile device 208.

Interactive financial interface 210 can run as an application or service on mobile device 208. Text messages sent by financial institutions 202, 204, and 206 to mobile device 208 can include information about accounts held at the financial institutions 202, 204, and 206 such as balances, transaction records and other types of information. The messages can also contain identifying information in the header (i.e. metadata) of the message that identifies which financial institution sent the message and the identity of the target recipient.

Interactive financial interface 210 can extract the financial account related data from text messages received by mobile device 208. Once analyzed by the interface, the data can be displayed on mobile device 208 in the form of charts and graphs that can facilitate financial decisions made by the user of mobile device 208.

The system 200 shown in FIG. 2 is similar to system 100 shown in FIG. 1 except that in the embodiment shown in FIG. 2, interactive financial interface 210 runs on the mobile device 208 instead of in the cloud or mobile network as shown in FIG. 1. Otherwise, the functionality remains similar.

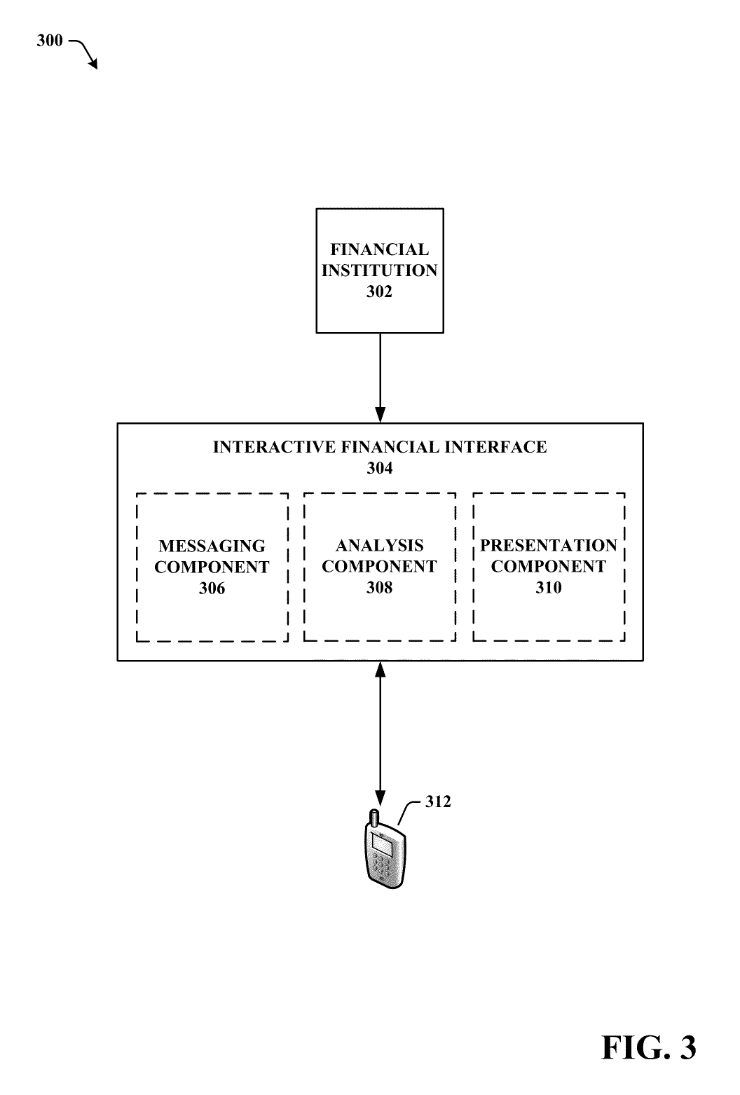

Turning now to FIG. 3, a block diagram illustrating an example, non-limiting embodiment of an interactive financial interface system 300 in accordance with various aspects described herein is shown. System 300 includes an interactive financial interface 304 that facilitates communications between financial institution 302 and mobile device 312 (or other electronic device). Interactive financial interface 304 includes a messaging component 306, an analysis component 308, and a presentation component 310. It is to be appreciated that the description of the interactive financial interface 304 and the underlying components can apply to both embodiments shown in FIGS. 1 and 2. It is also to be appreciated, that for the sake of simplicity, the embodiment shown in FIG. 3 includes only one financial institution, financial institution 302. In other embodiments, interactive financial interface 304 can interact and receive messages from more than one financial institution.

The messaging component 306 can receive a text message from a financial institution 302, wherein the text message comprises transaction information about a transaction that is associated with the financial institution. The text message can contain information about one or more accounts held at financial institution 302. The text message can also contain identifying information in the header (i.e., metadata) that identifies financial institution 302 and the identity of the target recipient.

In some embodiments, messaging component 306 can intercept text messages sent to mobile device 312, and in other embodiments, it can extract the data from the text messages after they have been received by mobile device 312. Messaging component 306 can passively receive and/or monitor text messages from financial institution 302 in some embodiments, and in other embodiments, messaging component 306 can send queries to financial institution 302 for information, and financial institution 302 can respond by sending a text message with data about the accounts held there.

Once the data about transaction and account information is extracted from the text messages, analysis component 308 can generate summary data based on an analysis of the transaction information and financial information that is determined prior to receiving the text message, wherein a type of summary data generated is based on a predetermined criterion. The financial information can include general contextual information such as income levels, credit rating and/or score, liabilities, assets, and etc. The financial information can be determined based on previous text messages, open source information, and/or information retrieved from financial institution 302 or a user of the mobile device 312. The summary data can include analysis about income and spending habits, cash flow analysis, trends, and etc.

The analysis component 308 can prepare different types of summary date based on predetermined criterion such as selections in the account settings of the interactive financial interface 304, financial institution 302 or mobile device 312. For instance, if a user desires to keep track of spending, the summary data can include analysis about spending habits or trends. If the selection is to facilitate financial planning, the summary data prepared by analysis component 308 can include analysis about liabilities, income and other relevant information. The types of summary data prepared can change in response to selections made by the user. For instance, once the summary data is displayed on mobile device 312, the user can select a different type of summary data, and analysis component 308 can run analyses on the transaction information and the financial information to generate the new summary data.

The presentation component 310 can be configured to display the transaction information, the financial information and the summary data on the mobile device 312. The information can be presented using charts, graphs, tables and other visual mechanisms. The graphs and charts can show balance over time, transactions, rates of funds being transferred in and out and other relationships, patterns, and diagrams that can be utilized for financial planning. The charts and graphs displayed on mobile device 312 can be sorted and filtered and otherwise manipulated for different views, perspectives, and analysis. For instance, the graphs can be filtered or sorted by time and/or date, transaction type, amount, and etc. Selections to change the presentation of the charts and graphs can be received via the mobile device 312.

As messaging component 306 receives additional messages from financial institution 302 or other financial institutions, messaging component 306 can extract the data from the additional messages and add it to the data received earlier. Analysis component 308 can use the new data to generate summary data to replace the previously determined summary data. The updated summary data can be dynamically displayed by the presentation component 310 to show real time, or near real time financial changes.

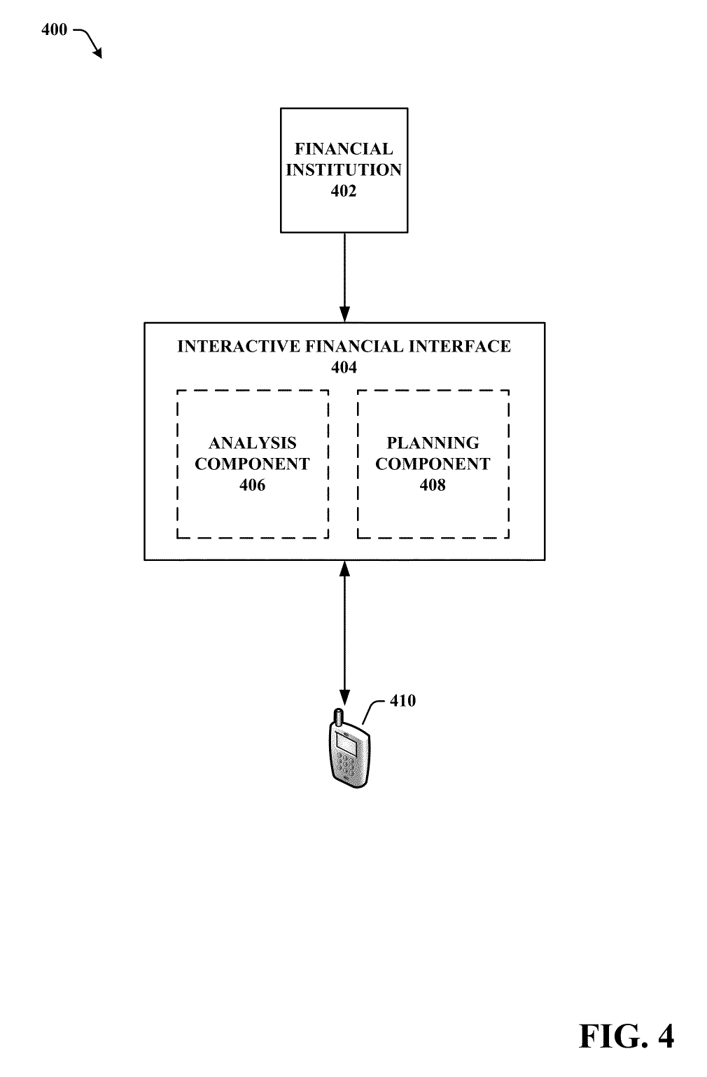

Referring now to FIG. 4, a block diagram illustrating an example, non-limiting embodiment of an interactive financial interface system 400 that makes financial recommendations in accordance with various aspects described herein is shown. System 400 includes interactive financial interface 404 that facilitates communications between financial institution 402 and mobile device 410. Interactive financial interface 404 includes analysis component 406 and planning component 408.

Analysis component 406 can prepare summary data based on the transaction information and financial information received from financial institution 402. Based on the summary data, the planning component 408 can create a financial plan based on the summary data to achieve a financial goal. Financial goals can include money saving goals, investment goals, loan payment goals, and goals to purchase or rent goods, property and/or services. Planning component 408 can use the summary data and other contextual data, such as banking information, social network activity, past activity, preferences, etc., to shape the financial plan to make it more effective and efficient. Banking accounts, social network accounts, loyalty program accounts, and others can be linked to the financial planning system to enable the financial planning system in gathering contextual background information.

In some embodiments, planning component 408 can dynamically update or suggest changes to the financial plan based on changes and/or additions to the summary data. These changes can include new or updated summary data, trend information about spending history, income level, and etc. In an embodiment, the planning component 408 can determine the best financial plan based on information related to the financial status of the user The planning component 408 can also infer the preferred plan based on past usage and/or other information about the user.

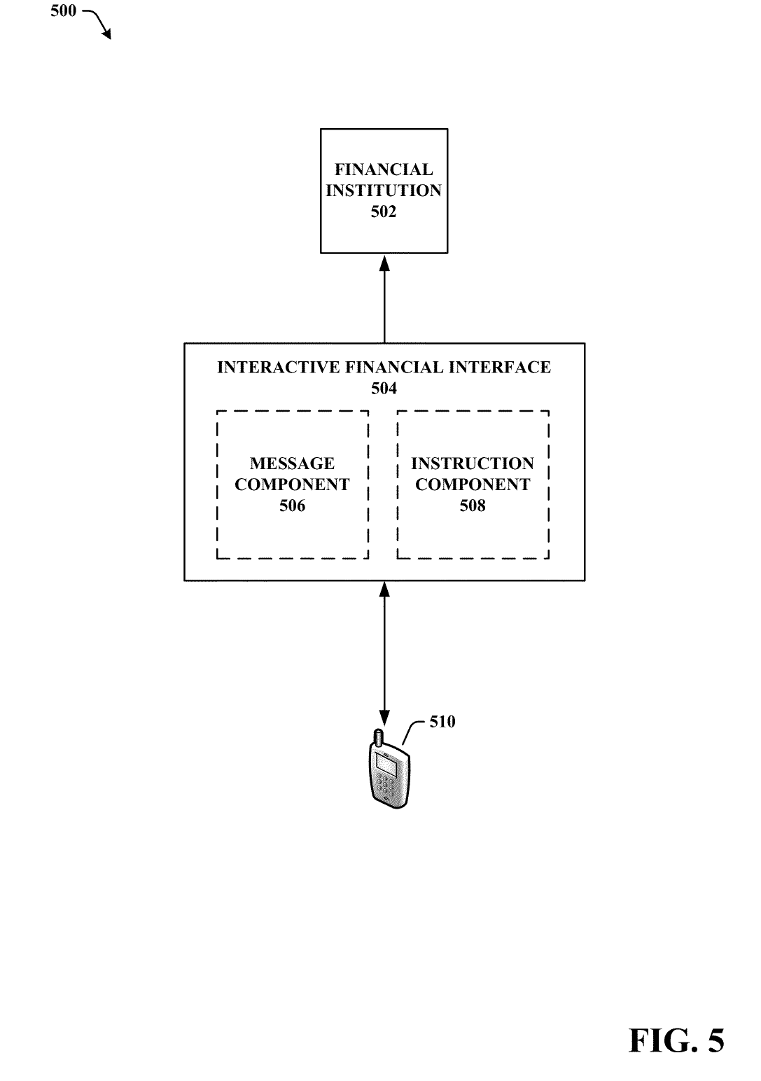

FIG. 5 illustrates a block diagram of an example, non-limiting embodiment of an interactive financial interface system 500 that sends instructions to the financial institutions in accordance with various aspects described herein. Interactive financial interface system 500 includes interactive financial interface 504 that can receive and send messages between financial institution 502 and mobile device 510. Interactive financial interface 504 can include a message component 506 that receives the messages and an instruction component 508 that is configured to send messages to the financial institution 502.

In some embodiments, interactive financial interface 504 can be used to send requests, instructions, and/or commands to financial institution 502. The instructions can indicate whether the financial institution 502 should initiate a transaction, transfer funds, change account settings, and/or undertake other actions. The instructions can be sent in a similar manner as the messages are received from the financial institution. For example, if messages are sent from financial institution 502 as a text message, instruction component 508 can send instructions to financial institution 502 as a text message in response.

In an embodiment, when the interactive financial interface 504 is not located on mobile device 510, instruction component 508 can prepare a message that includes metadata that identifies the message as if it were sent from mobile device 510 associated with a bank account at a financial institution. In this way, financial institution 502 receives no indication that the message originated from interactive financial interface 504 and not mobile device 510.

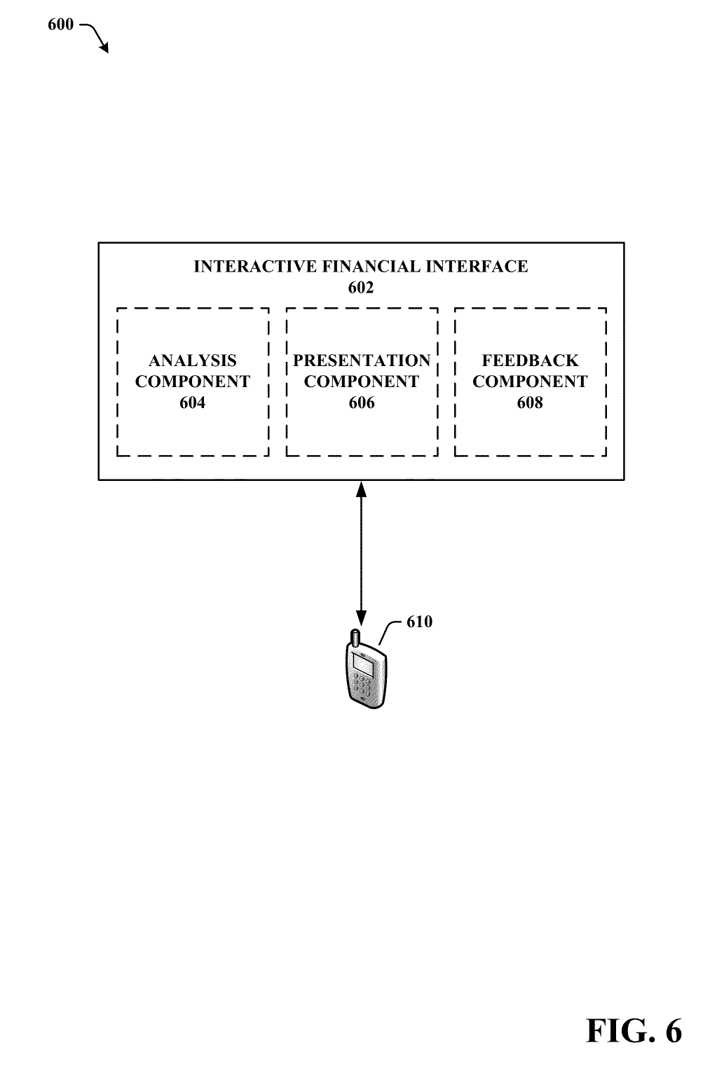

Turning now to FIG. 6, a block diagram illustrating an example, non-limiting embodiment of an interactive financial interface system 600 that can be organized and rearranged in accordance with various aspects described herein is shown. Interactive financial interface system 600 includes an interactive financial interface 602 that analyzes financial and transaction information, and displays a summary of the analysis on a mobile device 610.

An analysis component 604 can analyze the financial and transaction information, a presentation component 606 can display the information on the mobile device 610, and a feedback component 608 can receive feedback from the mobile device 610 in order to manipulate the presentation of data to gain different views or understandings of the information. Feedback component 608 can receive feedback from the mobile device 610 and rearrange the presentation of the transaction information based on at least one of a date of the transaction, an amount of the transaction, and a party associated with the transaction.

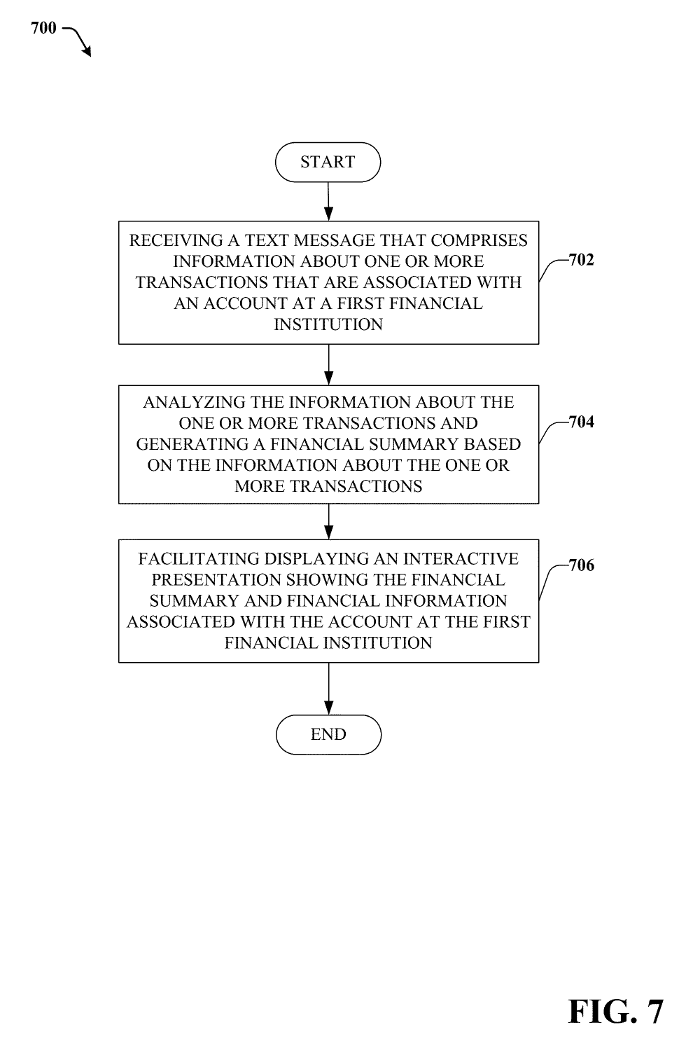

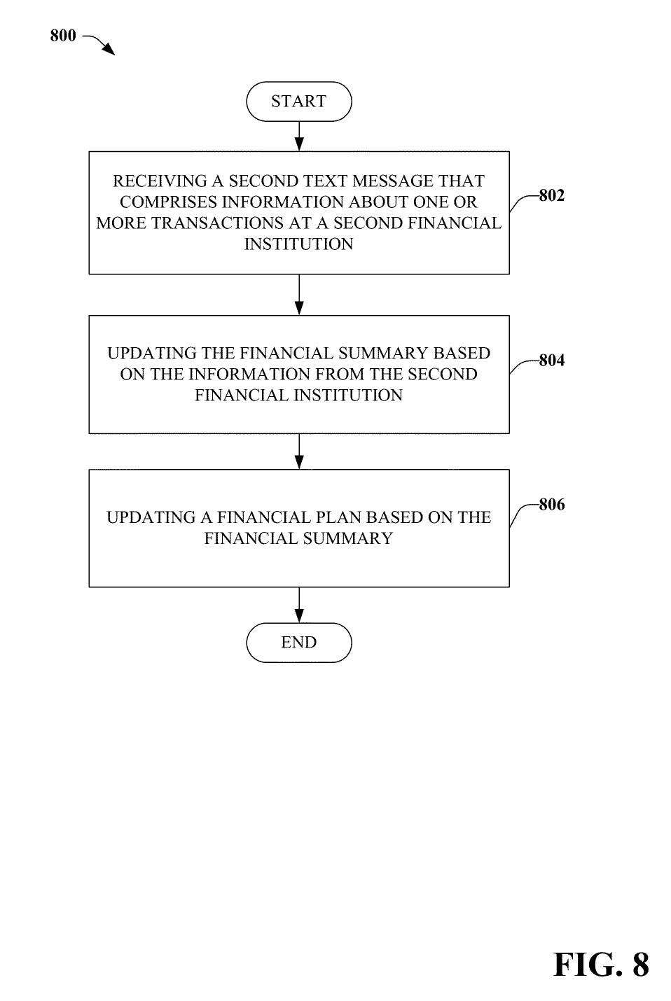

In view of the example systems 100-600 described above, methods that may be implemented in accordance with the described subject matter may be better appreciated with reference to the flow charts of FIGS. 7 and 8. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, illustrated is an example methodology 700 for financial planning in accordance with aspects described herein. Methodology 700 can begin at block 702, wherein a text message that comprises information about one or more transactions that are associated with an account at a first financial institution is received (e.g., by messaging component 306). The text message can also contain identifying information in the header (i.e., metadata) that identifies the financial institution and the identity of the target recipient.

At 704, the information about the one or more transaction us analyzed, and a financial summary based on the information about the one or more transactions is generated (e.g., by analysis component 308). The summary information can be based on financial information about the user as well, where the financial information can include general contextual information such as income levels, credit rating and/or score, liabilities, assets, and etc. The financial information can be determined based on previous text messages, open source information, and/or information retrieved from the financial institution or the customer. The summary data can include analysis about income and spending habits, cash flow analysis, trends, and etc.

At 706, an interactive presentation showing the financial summary and financial information associated with the account at the first financial institution is displayed (e.g., by presentation component 310). The interactive presentation can be displayed on a mobile device in some embodiments, and in other embodiments it can be displayed on other types of electronic devices.

The information can be presented using charts, graphs, tables and other visual mechanisms. The graphs and charts can show balance over time, transactions, rates of funds being transferred in and out and other relationships, patterns, and diagrams that can be utilized for financial planning. The charts and graphs displayed on the mobile device and/or electronic device can be sorted and filtered and otherwise manipulated for different views, perspectives, and analysis. For instance, the graphs can be filtered or sorted by time and/or date, transaction type, amount, and etc. Selections to change the presentation of the charts and graphs can be received via the mobile device and/or electronic device.

Turning now to FIG. 8, illustrated is an example methodology 800 for employing an interactive financial interface as described herein. Methodology 800 can begin at block 802, where a second text message that comprises information about one or more transactions at a second financial institution is received. An text message received earlier can have contained information about a transaction related to a first financial institution. Based on that first message, a financial summary can be generated to provide contextual information or a summary to assist in financial planning to achieve a financial goal. At 804, the financial summary based on the information from the second financial institution is updated. At 806, a financial plan is updated based on the financial summary.

### Example Computing Environment

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 9 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 9 thus illustrates an example of a suitable computing system environment 900 in which some aspects of the disclosed subject matter can be implemented, although as made clear above, the computing system environment 900 is only one example of a suitable computing environment for a device and is not intended to suggest any limitation as to the scope of use or functionality of the disclosed subject matter. Neither should the computing environment 900 be interpreted as having any dependency or requirement relating to any one or combination of components illustrated in the exemplary operating environment 900.

With reference to FIG. 9, an exemplary device for implementing the disclosed subject matter includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures.

Computer 910 typically includes a variety of computer readable media. Computer readable media can be any available media that can be accessed by computer 910. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules, or other data in a modulated data signal such as a carrier wave or other transport mechanism and includes any information delivery media.

The system memory 930 may include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, may be stored in memory 930. Memory 930 typically also contains data and/or program modules that are immediately accessible to and/or presently being operated on by processing unit 920. By way of example, and not limitation, memory 930 may also include an operating system, application programs, other program modules, and program data.

The computer 910 may also include other removable/non-removable, volatile/nonvolatile computer storage media. For example, computer 910 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 921 through a non-removable memory interface such as an interface, and a magnetic disk drive or optical disk drive is typically connected to the system bus 921 by a removable memory interface, such as an interface.

A user can enter commands and information into the computer 910 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 920 through user input 940 and associated interface(s) that are coupled to the system bus 921, but may be connected by other interface and bus structures, such as a parallel port, game port, or a universal serial bus (USB). A graphics subsystem can also be connected to the system bus 921. A projection unit in a projection display device, or a HUD in a viewing device or other type of display device can also be connected to the system bus 921 via an interface, such as output interface 950, which may in turn communicate with video memory. In addition to a monitor, computers can also include other peripheral output devices such as speakers which can be connected through output interface 950.

The computer 910 can operate in a networked or distributed environment using logical connections to one or more other remote computer(s), such as remote computer 970, which can in turn have media capabilities different from device 910. The remote computer 970 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 910. The logical connections depicted in FIG. 9 include a network 971, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 910 can be connected to the LAN 971 through a network interface or adapter. When used in a WAN networking environment, the computer 910 can typically include a communications component, such as a modem, or other means for establishing communications over the WAN, such as the Internet. A communications component, such as wireless communications component, a modem and so on, which can be internal or external, can be connected to the system bus 921 via the user input interface of input 940, or other appropriate mechanism. In a networked environment, program modules depicted relative to the computer 910, or portions thereof, can be stored in a remote memory storage device. It will be appreciated that the network connections shown and described are exemplary and other means of establishing a communications link between the computers can be used.

### Example Networking Environment

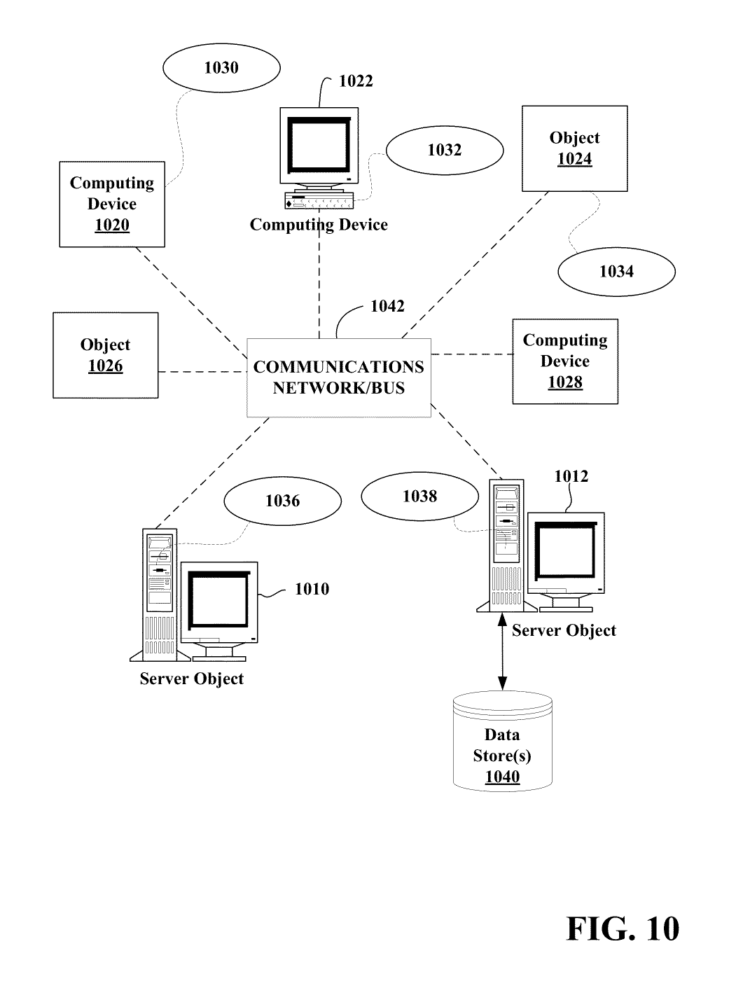

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, including multimedia display device 100 or similar devices depicted within the illustrations, or other devices such as a mobile phone, personal digital assistant (PDA), audio/video device, MP3 players, personal computer, laptop, etc. It should be further appreciated that data store(s) 1040 can include data store 108, or other similar data stores disclosed herein.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Example Mobile Network Platform

FIG. 11 presents an example embodiment 1100 of a mobile network platform 1110 that can implement and exploit one or more aspects of the disclosed subject matter described herein. Generally, wireless network platform 1110 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1110 can be included in telecommunications carrier networks, and can be considered carrier-side components as discussed elsewhere herein. Mobile network platform 1110 includes CS gateway node(s) 1112 which can interface CS traffic received from legacy networks like telephony network(s) 1140 (e.g., public switched telephone network (PSTN), or public land mobile network (PLMN)) or a signaling system #7 (SS7) network 1170. Circuit switched gateway node(s) 1112 can authorize and authenticate traffic (e.g., voice) arising from such networks. Additionally, CS gateway node(s) 1112 can access mobility, or roaming, data generated through SS7 network 1170; for instance, mobility data stored in a visited location register (VLR), which can reside in memory 1130. Moreover, CS gateway node(s) 1112 interfaces CS-based traffic and signaling and PS gateway node(s) 1118. As an example, in a 3GPP UMTS network, CS gateway node(s) 1112 can be realized at least in part in gateway GPRS support node(s) (GGSN). It should be appreciated that functionality and specific operation of CS gateway node(s) 1112, PS gateway node(s) 1118, and serving node(s) 1116, is provided and dictated by radio technology(ies) utilized by mobile network platform 1110 for telecommunication.

In addition to receiving and processing CS-switched traffic and signaling, PS gateway node(s) 1118 can authorize and authenticate PS-based data sessions with served mobile devices. Data sessions can include traffic, or content(s), exchanged with networks external to the wireless network platform 1110, like wide area network(s) (WANs) 1150, enterprise network(s) 1170, and service network(s) 1180, which can be embodied in local area network(s) (LANs), can also be interfaced with mobile network platform 1110 through PS gateway node(s) 1118. It is to be noted that WANs 1150 and enterprise network(s) 1160 can embody, at least in part, a service network(s) like IP multimedia subsystem (IMS). Based on radio technology layer(s) available in technology resource(s) 1117, packet-switched gateway node(s) 1118 can generate packet data protocol contexts when a data session is established; other data structures that facilitate routing of packetized data also can be generated. To that end, in an aspect, PS gateway node(s) 1118 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1100, wireless network platform 1110 also includes serving node(s) 1116 that, based upon available radio technology layer(s) within technology resource(s) 1117, convey the various packetized flows of data streams received through PS gateway node(s) 1118. It is to be noted that for technology resource(s) 1117 that rely primarily on CS communication, server node(s) can deliver traffic without reliance on PS gateway node(s) 1118; for example, server node(s) can embody at least in part a mobile switching center. As an example, in a 3GPP UMTS network, serving node(s) 1116 can be embodied in serving GPRS support node(s) (SGSN).

For radio technologies that exploit packetized communication, server(s) 1114 in wireless network platform 1110 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1110. Data streams (e.g., content(s) that are part of a voice call or data session) can be conveyed to PS gateway node(s) 1118 for authorization/authentication and initiation of a data session, and to serving node(s) 1116 for communication thereafter. In addition to application server, server(s) 1114 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1110 to ensure network's operation and data integrity in addition to authorization and authentication procedures that CS gateway node(s) 1112 and PS gateway node(s) 1118 can enact. Moreover, provisioning server(s) can provision services from external network(s) like networks operated by a disparate service provider; for instance, WAN 1050 or Global Positioning System (GPS) network(s) (not shown). Provisioning server(s) can also provision coverage through networks associated to wireless network platform 1110 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1175.

It is to be noted that server(s) 1114 can include one or more processors configured to confer at least in part the functionality of macro network platform 1110. To that end, the one or more processor can execute code instructions stored in memory 1130, for example. It is should be appreciated that server(s) 1114 can include a content manager 1115, which operates in substantially the same manner as described hereinbefore.

In example embodiment 1100, memory 1130 can store information related to operation of wireless network platform 1110. Other operational information can include provisioning information of mobile devices served through wireless platform network 1110, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1130 can also store information from at least one of telephony network(s) 1140, WAN 1150, enterprise network(s) 1160, or SS7 network 1170. In an aspect, memory 1130 can be, for example, accessed as part of a data store component or as a remotely connected memory store.

As used herein, the term “text message” is used to mean a brief electronic message that is sent to or from a mobile device over a mobile network. SMS messages are one form of text message using a standardized protocol. Other communication protocols sending electronic messages over mobile networks are also covered by this disclosure.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers. Further, these components can execute from various non-transitory computer-readable media having various data structures stored thereon. In this regard, the terms “non-transitory” and “tangible” herein as applied to storage, memory or computer-readable media, is to be understood to exclude only propagating transitory signals per se as a modifier and does not relinquish all standard storage, memory or computer-readable media that are not only propagating transitory signals per se.

The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a memory to store computer-executable instructions; and
a processor, communicatively coupled to the memory, which facilitates execution of the computer-executable instructions to at least:
receive a text message from a financial institution, wherein the text message comprises transaction information about a transaction that is associated with the financial institution;
generate summary data based on an analysis of the transaction information and financial information that is determined prior to receiving the text message, wherein a type of summary data is generated based on a defined criterion; and
facilitate display of the transaction information, the financial information, and the summary data on a mobile device.

2. The system of claim 1, wherein the processor further facilitates the execution of the computer-executable instructions to:
change the type of summary data generated based on a received selection.

3. The system of claim 1, wherein the processor further facilitates the execution of the computer-executable instructions to:
receive a second text message from a second financial institution with transaction information about a second transaction; and
generate updated summary data based on previous summary data and the transaction information about a second transaction.

4. The system of claim 3, wherein the updated summary data includes trend data.

5. The system of claim 4, wherein the processor further facilitates the execution of the computer-executable instructions to:
modify a financial plan associated with a financial goal based on the trend data.

6. The system of claim 1, wherein the processor further facilitates the execution of the computer-executable instructions to:
identify the financial institution based on metadata in the text message.

7. The system of claim 1, wherein the processor further facilitates the execution of the computer-executable instructions to:
create a financial plan associated with a financial goal based on the summary data.

8. The system of claim 1, wherein the processor further facilitates the execution of the computer-executable instructions to:
rearrange a presentation of the transaction information based on at least one of a date of the transaction, an amount of the transaction, or a party associated with the transaction.

9. The system of claim 1, wherein the processor further facilitates the execution of the computer-executable instructions to:
send a message to the financial institution, wherein the message includes metadata that identifies the message as having been sent from a mobile device associated with a bank account at a financial institution.

10. The system of claim 9, wherein the message is at least one of an email message or a text message.

11. The system of claim 9, wherein the message comprises an instruction for the financial institution to initiate a transaction.

12. A method, comprising:
receiving, by a system comprising at least one processor, a text message that comprises information about one or more transactions that are associated with an account at a first financial institution;
analyzing the information about the one or more transactions and generating a financial summary based on the information about the one or more transactions; and
facilitating displaying an interactive presentation showing the financial summary and financial information associated with the account at the first financial institution.

13. The method of claim 12, further comprising displaying the interactive presentation on a mobile device.

14. The method of claim 12, further comprising changing the financial summary based on feedback received via the interactive presentation.

15. The method of claim 12, further comprising:
receiving a second text message that comprises information about one or more transactions at a second financial institution; and
updating the financial summary based on the information from the second financial institution.

16. The method of claim 12, further comprising identifying a financial institution that sent the text message based on metadata in the text message.

17. The method of claim 12, further comprising generating a financial plan to achieve a financial goal based on the financial summary and the financial goal.

18. The method of claim 15, further comprising updating a financial plan based on the financial summary.

19. The method of claim 12, further comprising sending a text message to the first financial institution, wherein the text message comprises instructions to initiate a transaction.

20. The method of claim 19, further comprising encoding metadata into the text message that identifies the message as being sent from a mobile device associated with the account at the first financial institution.

21. A tangible computer-readable storage device comprising computer-executable instructions that, in response to execution, cause a system comprising a processor to perform operations, comprising:
gathering data from a text message that was sent to a mobile device from a financial institution, wherein the data relates to transactions associated with a financial institution account;
determining a financial trend based on an analysis of the data; and
generating an interactive presentation summarizing the financial trend, wherein the interactive presentation is organized based on a defined criterion.

22. The tangible computer-readable storage device of claim 21, wherein the operations further comprise:
creating a financial plan for a financial goal based on the financial trend.

23. The tangible computer-readable storage device of claim 21, wherein the operations further comprise:
rearranging the interactive presentation based on at least one of a date of the transactions, an amount of the transactions, or respective parties associated with the transactions.
